(19) United States
(12) Patent Application Publication
(10) Pub. No.: US 2002/0183903 A1
(43) Pub. Date: Dec. 5, 2002

(54) Dynamic technique for using corrective shock absorbing actions on vehicles

(75) Inventors: Menachem Levanoni, Yorktown Heights, NY (US); Jerome M. Kurtzberg, Yorktown Heights, NY (US)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/874,422

(22) Filed: Jun. 5, 2001

(51) Int. Cl. G06F 19/00

(52) U.S. Cl. 701/29

(57) ABSTRACT

A method utilizing continual sensor-based data to design an adjustable set of corrective shock absorbing jets for a vehicle. The invention capabilities include cognizance of the dynamic workings of the vehicle in a changing real environment. For example, the forces and accelerations experienced by the vehicle during normal driving operations, may be taken into design account, to thereby provide an optimal balance between safety, support, and comfort.

### BACKGROUND OF THE INVENTION

1. Field of the Invention

This invention relates to methodology for utilizing continual sensor-based data to design and adjust corrective shock absorbing actions on vehicles experiencing out-of-control-conditions, in a given dynamic environment, due to bumpy rides.

2. Introduction to the Invention

Current techniques to control bumpy rides rely on driver's skill and are not very effective. Automatic corrective shock absorbing actions techniques do not exist. Only static mechanical/hydrolic shock absorbers are in effect today. We note, here, that no attention is given to the dynamic workings of the vehicle in the changing real environment. Specifically, the stresses and accelerations experienced by the vehicle during normal operation are not taken into account, nor is an optimum balance, between safety and comfort, taken into account.

### SUMMARY OF THE INVENTION

We have now discovered novel methodology for exploiting advantages inherent generally in sensing the dynamic workings (forces) on specific vehicles in actual motion, and using this sensor-based data to improve or optimize the construction and operation of corrective shock absorbing actions tools.

Our work proceeds in the following way.

We have recognized that a typical and important paradigm for presently controlling bumpy rides, is a largely static and subjective human paradigm, and therefore exposed to all the vagaries and deficiencies otherwise attendant on static and human procedures. In sharp contrast, the novel paradigm we have in mind works in the following way.

First, a vehicle is equipped with a set of force and accelerations sensors mounted, say, inside a vehicle-encasing device (harness). These sensors record their associated forces and accelerations produced in normal vehicular motion in its dynamic environment for a prescribed period of time, preferably sufficient to capture all possible force and acceleration patterns.

The dynamically acquired data are fed into a computer which creates a map of the forces and accelerations experienced by the examined vehicle. This information may be used to design a preferably optimal set of corrective shock absorbing jets which preferably maximizes support and minimizes discomfort, and result in a computer-based construction of said set of jets that offers preferably optimal performance to the examined vehicle in its normal operation. This physical set of attitude jets preferably provides maximum safety, support and maximal comfort to its driver and passengers, following the optimal design of the corrective shock absorbing jets.

Accordingly, we now disclose a novel computer method which can preserve the advantages inherent in the static approach, while minimizing the incompleteness and attendant static nature and subjectivities that otherwise inure in techniques heretofore used.

To this end, in a first aspect of the present invention, we disclose a novel computer method comprising the steps of:

i) mounting pressure and acceleration sensors in a vehicle-enclosing device;

ii) transmitting data produced by said sensors during actual operation of said body-enclosing device attached to a specific vehicle; and

iii) creating a force-and-acceleration map based on said sensor-based data.

Preferably, the method includes a step for designing a model for a set of corrective shock absorbing jets providing thereby optimal safety, support, and comfort based on the force-and-acceleration map; and, preferably includes a further step of constructing a physical set of jets based on a design provided by the model.

### BRIEF DESCRIPTION OF THE DRAWING

The invention is illustrated in the accompanying drawing, in which:

FIG. 1 provides an illustrative flowchart comprehending overall realization of the method of the present invention.

### DETAILED DESCRIPTION OF THE PRESENT INVENTION

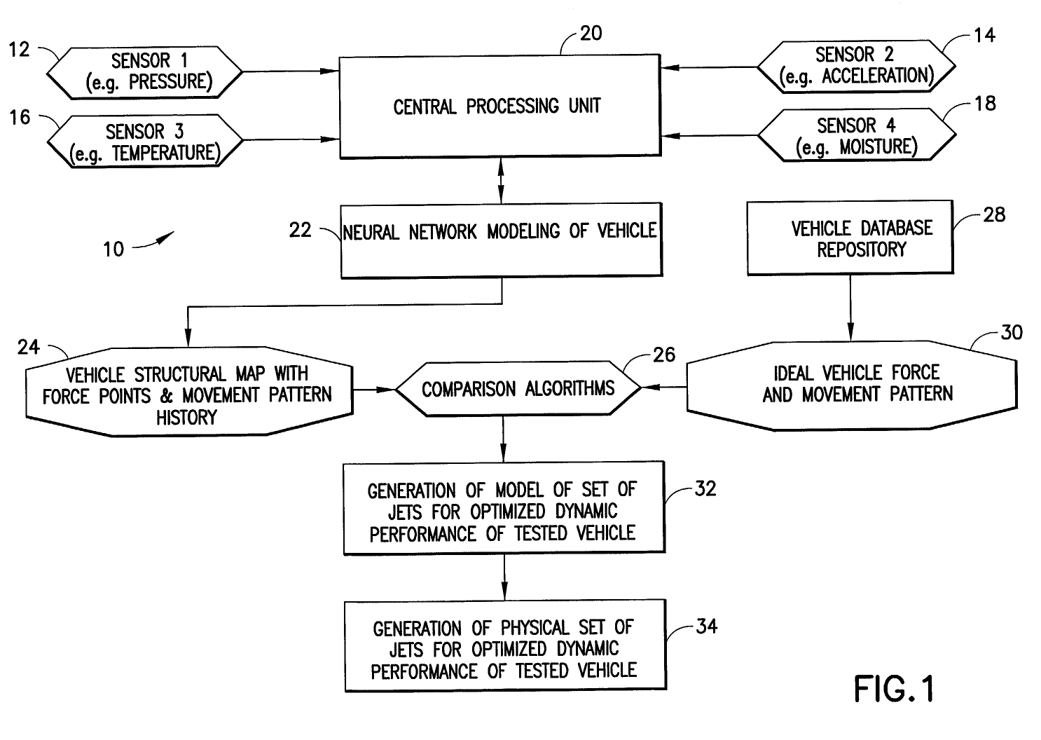

Attention is now directed to FIG. 1, which provides an overview flowchart (numerals 10-34) for typical and illustrative realization of the present invention.

In a typical case, a vehicle may be fitted with a temporary harness comprising a number of sensors (12, 14, 16, 18), located at prescribed locations on the tested vehicle. These sensors may include conventional force, acceleration, temperature, and/or humidity capabilities, and are preferably connected to a conventional recording device.

The harness fitted vehicle goes through its normal routine for several operational days. During the test period, sensor data are recorded (including time stamps) in the recording device. Then the harness and the recording device are returned at the end of the test period. The information stored in the recording device is then downloaded to a computer (20), which can store all data in a database.

The data are then analyzed by a program (preferably a neural network modeling program), which can create maps of the tested vehicle at different times and road conditions. These maps also contain the sensors' reading at these times and conditions. Thus, this system now has information on the dynamic behavior of the tested vehicle, including parametric information.

Based on these maps, and maps of an ideal vehicle under similar conditions, an optimization program (32) designs an optimized set of jets for the vehicle. This design is then fed to a system (34) which can generate an optimized physical set of jets.

What is claimed:

1. A computer method comprising the steps of:
i) mounting force and acceleration sensors in a vehicle-enclosing device;
ii) transmitting data produced by said sensors during actual operation of said vehicle-enclosing device attached to a specific vehicle for subsequent analysis by a computer; and
iii) creating a force-and-acceleration map based on said sensor-based data.

2. A computer method according to claim 1, comprising a step of creating a model of a set of corrective shock absorbing jets for safety, support and comfort based on the force-and-acceleration map.

3. A computer method according to claim 2, comprising a step of constructing a physical set of jets based on a design provided by the model.

4. A method according to claim 1, comprising a step of using a sensor selected from the group consisting of temperature, moisture, and road conditions so that sensor output may be correlated with safety, support and comfort when using a physical set of jets.

5. A method according to claim 2, comprising a step of using an interpolation technique to completely map forces and accelerations experienced by a vehicle over a period of time.

6. A method according to claim 5, comprising a step of updating the model by using the interpolating map.

7. A method according to claim 6, comprising a step of using the interpolated map to directly design the model in an optimal manner.

8. A method according to claim 1, comprising a step of using a linear technique to model a set of attitude jets.

9. A method as in claim 8, comprising a step of employing neural networks as the modeling technique.

10. A method according the claim 8, comprising astep of employing regression as the modeling technique.

11. A method according to claim 8, comprising a step of employing expert systems as the modeling technique.

12. A program storage device readable by machine, tangibly embodying a program of instructions executable by the machine to perform method steps for correcting shock absorbing actions on vehicles, the method comprising the steps of:
i) mounting force and acceleration sensors in a vehicle-enclosing device;
ii) transmitting data produced by said sensors during actual operation of said vehicle-enclosing device attached to a specific vehicle for subsequent analysis by a computer; and
iii) creating a force-and-acceleration map based on said sensor-based data.
